(19) United States
(12) Patent Application Publication
(10) Pub. No.: US 2025/0153980 A1
(43) Pub. Date: May 15, 2025

(54) SYSTEM FOR SAFE AUTOMATED LASHING OF CONTAINER CRANE FOR PROTECTION AGAINST TYPHOONS

(71) Applicant: DOOTECH CO., LTD., Changwon-si, Gyeongsangnam-do (KR)

(72) Inventors: Jong Sam PARK, Changwon-si, Gyeongsangnam-do (KR); Sung Jae KIM, Changwon-si, Gyeongsangnam-do (KR)

(73) Assignee: DOOTECH CO., LTD., Changwon-si, Gyeongsangnam-do (KR)

(21) Appl. No.: 18/838,314

(22) PCT Filed: Jul. 18, 2022
(86) PCT No.: PCT/KR2022/010436

§ 371 Date: Aug. 14, 2024

(30) Foreign Application Priority Data
Feb. 15, 2022 (KR) 10-2022-0019219

(51) Int. Cl. B66C 15/00

(52) U.S. Cl. CPC B66C 15/00; B66C 2700/084; B66C 2700/088

(57) ABSTRACT

An automated system mainly includes a stowage module (100), a tiedown module (200), a socket anchor module (300), and an encoder module (400) and has an improved structure for a stowage pin and the tiedown module to be remotely controlled by unmanned automation to significantly decrease the crane securing time, thereby promptly dealing with emergency situations with maximum terminal operation efficiency and minimum manpower.

### TECHNICAL FIELD

The present invention relates to an automated system for safely securing container cranes against storm wind, and more particularly, to an automated system for safely securing container cranes that has an improved structure in which a stowage module and a tiedown module are remotely controlled by unmanned automation and can therefore significantly decrease the crane securing time to about 1/25 per crane and about 1/500 based on a total of 20 cranes in a terminal compared to a manual type, thus promptly dealing with emergency situations, such as storm wind, with maximum terminal operation efficiency and minimum manpower, and in particular, by recording data of an overload applied to a tiedown module (200) at the time of storm wind using a monitoring system including a load cell and keeping, managing, and analyzing the data as big data, can pre-identify information of a tiedown module expected to be damaged, an expected degree of damage, and the like, predict failures and critical accidents through non-destructive inspection or the like of whether the corresponding module is damaged, and by controlling pre-tension to be evenly applied to each tiedown module (200), can prevent secondary accidents including the occurrence of tiedown module breakage accidents due to a local overload applied only to any one tiedown module (200) and the collapse of the entire crane caused thereby, and the occurrence of local deformations of a structure.

### BACKGROUND ART

Generally, due to a wind load caused by storm wind, a horizontal force of 300 tons or more and tipping moment are generated to the entire crane, safety fixing devices are applied to prepare for such force and moment, and as the safety fixing devices, a stowage pin device (stowage pin assembly) is basically installed as a safety device for a crane being pushed due to the horizontal force, and a tiedown device (tiedown assembly) is basically installed as a safety device for a crane being overturned due to the tipping moment.

Such safety fixing devices are essential safety equipment that should be installed at container handling port equipment as well as all cranes that are installed and operated in an outdoor area directly affected by storm wind. A defect or a problem in fastening of the fixing device is a key factor that should be managed in the safety device because it may lead to the collapse of the entire crane due to collision with a nearby crane and overturning of the crane caused by the displacement of the crane. When a defect or a problem in fastening of the fixing device is not properly managed, major accidents may occur. As a representative example, in September 2003, Typhoon Maemi caused damage to a tiedown bracket of a container crane in the north port of Busan port and led to a collapse accident of six cranes. This is a case that shows the importance of the design and maintenance management of fixing devices.

Here, the stowage pin device (stowage pin assembly) is a device in which a circular or quadrangular pin is inserted into a pin hole installed at a bottom of a pier to resist horizontal pushing caused by a wind load and which is operated by manually operating a lever that lifts and lowers the pin. Generally, a total of four stowage pin devices, two at the land side and two at the sea side, are installed at a dedicated structure (stowage frame) located at the center of a lower structure (sill beam) at the land side and sea side of a crane.

Also, as the tiedown devices (tiedown assembly), generally, one or two sets are installed at each of four corners of a lower structure (sill beam) of a leg of a crane, a bracket fixed by an anchor bolt is installed at a bottom of a pier, a rotatable link is installed at an end of a length-adjustable turnbuckle, and a pin is fastened to the bracket by a worker's force to hold down the crane. Since it is impossible to rotate the turnbuckle of the tiedown device having a weight of 1 ton or more by manpower, a separate ratchet device is mounted on the turnbuckle to increase a rotational force and adjust the length of the turnbuckle for fastening. However, it is, in fact, not easy to perform the length adjustment task due to a phenomenon in which the weight of the tiedown device increases due to an increase in the wind load caused by an increase in the wind speed and a size increase of the crane.

That is, although a large amount of resources (manpower, fastening/unfastening time) is required for a task of fastening and unfastening the tiedown device (tiedown assembly) due to difficulty of a task of aligning the bracket fixed at a predetermined position on the bottom of the pier and the turnbuckle/link hung on the crane, the fastening and unfastening task is only performed manually.

The stowage pin device and the tiedown device are produced and supplied according to crane suppliers' unique design methods and criteria without having particular set standards. However, installation sites, operation structures, concepts, and the like are generally almost the same, the fixing devices for protection against storm wind are mounted on all cranes installed in an outdoor area greatly affected by wind, and in the case of ports, the fixing devices are used by being mounted on container cranes and transfer cranes, and a dockyard Goliath crane, a jib crane, a loader and an unloader for a steel mill (a ship loader, a continuous ship unloader (CSU), a grab type ship unloader (GTSU)), and an unloader and a stacker-reclaimer (STRE) for a thermoelectric power plant (a CSU, a STRE) are typical cranes on which the fixing devices are mounted. The fixing devices are mounted and operated in about 800 pieces of port equipment in domestic ports and railway freight transportation facilities, and in consideration of equipment operating in dockyards, steel mills, thermoelectric power plants, and the like, the fixing devices are mounted and operated in thousands of pieces of large-scale equipment.

However, in a case in which it is impossible to assign even pre-tension to each tiedown device due to difficulty of performing the task of adjusting the length of high-weight tiedown devices just by a worker's force, and thus the tiedown devices are fastened in a state in which a tiedown device at one side is loosened and a tiedown device at another side is tightened, when an actual external force caused by storm wind is applied to the tiedown devices, due to the pre-tension being unevenly applied to the tiedown devices, a local overload is generated only on a tightened tiedown module (200), which may lead to the occurrence of breakage accidents of the tightened tiedown device and the collapse of the entire crane and secondary problems such as the occurrence of local deformations of a crane structure.

Also, when excessive stress exceeding allowable stress is locally generated on a specific tiedown device and local deformation occurs as a result, there is a problem in that there is a possibility of sudden damage to a tiedown module and the collapse of the crane caused thereby due to local deformation or continuous reuse due to the absence of a damage identification device.

Further, when performing a task of fastening/unfastening a tiedown device, a conventional method of manually fastening or unfastening a tiedown device by fitting or removing a pin is difficult to perform and has a problem in that three to four workers and a large amount of fastening and unfastening time of two hours or more are required per container crane, and due to the securing devices having a large size and a high weight, accidents that threaten safety of workers performing the fastening/unfastening task may occur.

### DISCLOSURE

### Technical Problem

Accordingly, the present invention has been devised to address the above-described problems and is directed to providing an automated system for safely securing container cranes that has an improved structure in which a stowage module and a tiedown module are remotely controlled by unmanned automation and can therefore significantly decrease the crane securing time to about 1/25 per crane and about 1/500 based on a total of 20 cranes in a terminal compared to a manual type, thus promptly dealing with emergency situations, such as storm wind, with maximum terminal operation efficiency and minimum manpower, and in particular, by recording data of an overload applied to a tiedown module (200) at the time of storm wind using a monitoring system including a load cell and keeping, managing, and analyzing the data as big data, can pre-identify information of a tiedown module expected to be damaged, an expected degree of damage, and the like, predict failures and critical accidents through non-destructive inspection or the like of whether the corresponding module is damaged, and by controlling pre-tension to be evenly applied to each tiedown module (200), can prevent secondary accidents including the occurrence of tiedown module breakage accidents due to a local overload applied only to any one tiedown module (200) and the collapse of the entire crane caused thereby, and the occurrence of local deformations of a structure.

### Technical Solution

To achieve the above objective, the present invention provides an automated system for safely securing container cranes against storm wind, the automated system including: a stowage module (100) installed at a lower structure (1) of each of a land-side leg and a sea-side leg of a crane and provided to be operated by a driving source including a thruster and engaged with a pin cup (2) installed at a bottom of a pier so that resistance to horizontal pushing caused by storm wind is applied thereto; a tiedown module (200) installed at the lower structure (1) of each of the land-side leg and the sea-side leg of the crane, length-adjusted by an expansion/contraction device (210), and having a twist lock pin (230) and a nut (223) configured to be turned by a turning device (220); a socket anchor module (300) mounted on anchoring hinges (3) installed to be fixed to the bottom of the pier by an anchor bolt and provided to be engaged with the twist lock pin (230) of the tiedown module (200) to bind the lower structure (1) of each of the land-side leg and the sea-side leg of the crane; and an encoder module (400) consisting of a traveling idle wheel (420), an idle shaft (430), and a connection coupling (440) for mounting an encoder (410) for controlling a traveling device to accurately stop the crane at a securing position.

Here, the stowage module (100) may include a stowage arm (110) configured to turn about a connection pin (112) by the driving source including the thruster, a stowage pin (120) connected to an end of the stowage arm (110) by a link piece (122) and provided to be engaged with the pin cup (2) by linearly moving in a vertical direction in association with the turning of the stowage arm (110), and a sensor (130) configured to detect an operational position of the stowage pin (120).

Also, the twist lock pin (230) of the tiedown module (200) may have a front end sharply protruding while forming a constant angle of inclination and have a pair of catching steps (232) formed at both ends, the socket anchor module (300) of the tiedown module (200) may have a long socket hole (310) formed to accommodate the twist lock pin (230), an inclined surface may be formed right below the long socket hole (310), a pair of stepped portions (320) may be disposed to be spaced apart from each other right below the inclined surface at an inlet of the long socket hole (310), and after the twist lock pin (230) moves over the inclined surface at a predetermined angle and sufficiently enters the long socket hole (310) via the stepped portions (320) due to expansion of upper and lower expansion/contraction rods (215, 216) and then the twist lock pin (230) turns (+) 90° due to an operation of a proximity switch (229), as the expansion/contraction device (210) is contracted, and upper surfaces of the catching steps (232) of the twist lock pin (230) come in contact with a lower surface of a lock groove (322) via the stepped portions, pre-tension may begin to be generated, and when pre-tension set by a load cell (219) is reached, the contraction may stop and a fastening task may be completed, and in a state in which the twist lock pin (230) in which expansion/contraction of the expansion/contraction device is stopped is fastened, since the catching steps (232) at both ends of the twist lock pin are engaged with the stepped portions (320) and turning (−) 90°, that is, loosening, is not possible, at the time of storm wind, an accident in which the crane is overturned due to the twist lock pin (230) being unfastened may be fundamentally prevented even when the tiedown module (200) shakes violently or the turning device (220) malfunctions.

Also, the expansion/contraction device (210) of the tiedown module (200) may include a worm gear (212) configured to rotate by being engaged with a worm (211) rotated by a driving source such as a motor installed inside or outside a worm gear box (2a) whose position is fixed to a crane main body by a pin, a position sensor mounted on the worm (211) to detect and control an expansion/contraction distance of the expansion/contraction device, upper and lower internal screw hollow shafts (213) (214) or an integrated internal screw hollow shaft integrally connected to both sides or an inner side of the worm gear (212), seated on a bearing (2d), and having internal screw portions formed in reverse directions from each other on an inner circumferential surface, an upper external screw expansion/contraction rod (215) screw-coupled to the upper internal screw hollow shaft (213) and having a securing holder (215a) formed at an end to be coupled to a main body bracket (1a), which is welded and attached to the lower structure (1) of each of the land-side leg and the sea-side leg of the crane, by a securing pin (1b), a lower external screw expansion/contraction rod (216) screw-coupled to the lower internal screw hollow shaft (214) and having the twist lock pin (230) turnably provided at an end, upper and lower guides (217) (218) configured to guide linear movement of the upper and lower external screw expansion/contraction rods (215) (216) which are pitch-moved in reverse directions from each other due to rotation of the upper and lower internal screw hollow shafts (213) (214), and the load cell (219) installed inside a frame (1c) welded and attached to both sides of the securing holder (215a) to mount the upper and lower guides, upper and lower boxes (2b, 2c) and guide holes (2bb, 2cc) configured to block rotation of the entire expansion/contraction device (210), and the securing pin (1b) to detect pre-tension applied to the tiedown module (200) and securing tension that is generated and applied at the time of storm wind, wherein values detected by the load cell (219) are collected and analyzed by a main control unit to detect and manage crane securing information including overloading of securing tension and eccentric loading of securing tension.

Also, the turning device (220) of the tiedown module (200) may include a lock pin holder (222) connected to an end of the lower external screw expansion/contraction rod (216) by a pin and having an axial hole (221) formed therethrough for the twist lock pin (230) to be rotatably inserted into the axial hole (221) to support and transfer a securing load, the nut (223) screw-fastened to an end of the twist lock pin (230) inserted to pass through the axial hole (221), a spherical seat (231) mounted on a lower surface of the nut and configured to allow the twist lock pin (230) to freely move in any direction by a predetermined gap within the axial hole (221) and allow the upper surfaces of the catching steps (232) at both ends of the twist lock pin (230) and the lower surface of the lock groove (322) to completely come in close contact, a rotation pin (227) configured to amplify a rotational force by connecting the nut (223) and a turning arm (224) controlling the turning of the twist lock pin (230) by expansion/contraction of a hydraulic or electric cylinder (225), the proximity switch (229) installed inside or outside a reference shaft (226), about which the turning arm (224) rotates, or the lock pin holder (222) to have an upper surface of the socket anchor module (300) as a detection target, and a position sensor (228) installed on a shaft of the cylinder (225) that controls a 900 turning section of the twist lock pin (230).

Also, the socket anchor module (300) of the tiedown module (200) may include a pair of support shafts (330) fastened to be fixed to the anchoring hinges (3) installed to be fixed to the bottom of the pier by an anchor bolt, and a socket body (340) having both ends restrained to the support shafts (330) to be rotatably installed and having the long socket hole (310) formed therein, wherein the socket body (340) may form a predetermined transverse correction gap (L1) movable in an axial direction of the support shafts (330) between the anchoring hinges (3), the position of the long socket hole (310) may be automatically corrected to coincide with the twist lock pin (230) as the position of the socket body (340) is moved in the axial direction of the support shafts (330) by the transverse correction gap (L1) or the socket body (340) is turned about the support shafts (330) due to a horizontal force caused by the protruding inclined surface of the twist lock pin (230) coming in contact with an inclined surface at an inlet of the socket body (340) while at a position not coinciding with the socket hole (310) due to being transferred downward, and when the twist lock pin (230) enters the long socket hole (310) while forming an angle misaligned with the long socket hole (310) within a predetermined allowable range, as a one-side inclined surface of the front end of the twist lock pin (230) and a one-side inclined surface of an inlet of the socket anchor module (300) come in contact due to an expansion force of the expansion/contraction device (210) that is generated by the driving source, rotating moment may be applied to the twist lock pin (230), and when the rotating moment of the twist lock pin (230) is large compared to an initial set pressure of the cylinder (225), as the cylinder is contracted or expanded, the twist lock pin (230) may be rotated, and the angle of the twist lock pin (230) may be automatically corrected so that the twist lock pin (230) enters the long socket hole (310), and an angle-of-rotation limiting stopper (2e) may be installed by welding or assembly to a side surface of the lock pin holder (222) to allow the lock pin holder (222) to rotate only within an angle (α) around 1 to 2° for the purpose of partially complementing functions of limiting excessive shaking due to acceleration or deceleration occurring during a traveling operation of a container crane and automatically correcting deviation amounts (a deviation in straightness of a traveling rail, a deviation in gaps between traveling wheel treads, a deviation in traveling, securing, and stopping positions) of the lock pin holder (222) assembled to the lower external screw expansion/contraction rod (216) by a pin.

Also, the socket body (340) may form a section of the socket hole (310) by a bottom plate (340a) serving as a balance weight and four side plates (340b) disposed at four sides of the bottom plate (340a), the bottom plate (340a) and the side plates (340b) may have a bolting assembly structure applied thereto to allow a center-of-mass position to be adjusted by adjusting the size of the bottom plate and cause the center of mass of the entire socket body to be biased toward lower portions of the support shafts (330) so that the inlet of the socket hole (310) always remains facing upward due to gravity for the twist lock pin (230) to be smoothly inserted into the socket hole (310), a cross shape (+) of the bottom plate may facilitate bolt assembly, a circular hole at a central portion may serve as a clearance for insertion of the twist lock pin (230), and although the height of the anchoring hinges (3) is minimized and a depth at which the anchoring hinges (3) are buried in the bottom of the pier is minimized, which makes it essential to add an installation space due to automation in which the socket anchor module (300) is added compared to a conventional manual type, by designing to minimize a necessary space such as a burying depth, an automation method may be easily modified and applied to a site to which the conventional manual type is applied, without separate modification work for a civil engineering part.

Also, the automated system may include an automation control system of the main control unit that includes a driving source, a sensor, a data collection device, a control programmable logic controller (PLC), and the like for automation of a task of securing the stowage module and the tiedown module,
a monitoring system configured to predict failures and accidents by analyzing and managing whether an overload has occurred, the size of the overload and an influence thereof on key components, whether a failure has occurred, whether replacement of components is necessary, and the like through collection and analysis of tension data including an overload occurring in key components of the tiedown module (200) detected by the load cell, and a pre-tension even distribution control device configured to,
by utilizing the tension detection function using the load cell (219), control set initial securing tension to be evenly applied to each tiedown module (200) using the worm (211) and the worm gear (212) to fundamentally prevent a local overload of more than allowable stress according to design from occurring in the tiedown module (200) due to an external force caused by storm wind and prevent the occurrence of breakage accidents and the collapse of the entire crane due to one-sided overloading.

### Advantageous Effects

According to the above configurations and actions, the present invention has an improved structure in which a stowage module and a tiedown module are remotely controlled by unmanned automation, and therefore can significantly decrease the crane securing time to about 1/25 per crane and about 1/500 based on a total of 20 cranes in a terminal compared to a manual type, thus promptly dealing with emergency situations, such as storm wind, with maximum terminal operation efficiency and minimum manpower, and in particular, by recording data of an overload applied to a tiedown module (200) at the time of storm wind using a monitoring system including a load cell and keeping, managing, and analyzing the data as big data, can pre-identify information of a tiedown module expected to be damaged, an expected degree of damage, and the like, predict failures and critical accidents through non-destructive inspection or the like of whether the corresponding module is damaged, and by controlling pre-tension to be evenly applied to each tiedown module (200), can prevent secondary accidents including the occurrence of tiedown module breakage accidents due to a local overload applied only to any one tiedown module (200) and the collapse of the entire crane caused thereby, and the occurrence of local deformations of a structure.

### DESCRIPTION OF DRAWINGS

FIG. 1 is a configuration diagram illustrating the overall automated system for safely securing container cranes according to one embodiment of the present invention.

FIG. 2 is a configuration diagram illustrating a manual type stowage module for container cranes that is in use according to one embodiment of the present invention.

FIG. 3 is a configuration diagram illustrating a stowage module of the automated system for safely securing container cranes according to one embodiment of the present invention.

FIG. 4 is a configuration diagram illustrating a manual type tiedown module for container cranes that is in use according to one embodiment of the present invention.

FIGS. 5 and 6 are configuration diagrams illustrating a state in which expansion/contraction of a tiedown module of the automated system for safely securing container cranes according to one embodiment of the present invention is controlled by an expansion/contraction device, wherein FIG. 5 is a view of a state in which the tiedown module is contracted while a crane is used, and FIG. 6 is a view of a state in which the tiedown module is completely secured and fastened at the time of storm wind.

FIG. 7 shows a view (A) of a state in which expansion is stopped after a proximity switch detection distance (L2) is reached via stepped portions due to the operation of the expansion/contraction device, a view (B) of a state in which 90° turning by a turning device is completed after detection of a proximity switch, and a view (C) of a state in which, when pre-tension set by a load cell (219) is reached after pre-tension begins to be generated as upper surfaces of catching steps (232) of a twist lock pin (230) come in contact with a lower surface of a lock groove (322) via the stepped portions due to a contracting operation of the expansion/contraction device after completion of 90° rotation is detected by a position sensor (228), the contracting operation is stopped and a fastening task is completed.

FIGS. 8 and 9 are configuration diagrams illustrating a state in which the position of a socket anchor module of the automated system for safely securing container cranes according to one embodiment of the present invention is corrected.

FIG. 10 is a configuration diagram illustrating a structure of the turning device of the automated system for safely securing container cranes according to one embodiment of the present invention and a state in which the twist lock pin is turned by the turning device.

FIG. 11 is a configuration diagram illustrating a socket body of the automated system for safely securing container cranes according to one embodiment of the present invention in an exploded state.

FIG. 12 is a configuration diagram illustrating an encoder module of the automated system for safely securing container cranes according to one embodiment of the present invention.

FIG. 13 is a configuration diagram illustrating an angle-of-rotation limiting stopper (2e) of a lock pin holder (222) of the automated system for safely securing container cranes according to one embodiment of the present invention.

FIG. 14 is a configuration diagram illustrating a control system conceptual diagram of the automated system for safely securing container cranes according to one embodiment of the present invention.

### MODES OF THE INVENTION

Hereinafter, exemplary embodiments of the present invention will be described in detail with reference to the accompanying drawings. Also, in describing the present invention, when it is determined that related known functions self-evident to those of ordinary skill in the art may unnecessarily obscure the gist of the present invention, detailed description thereof will be omitted.

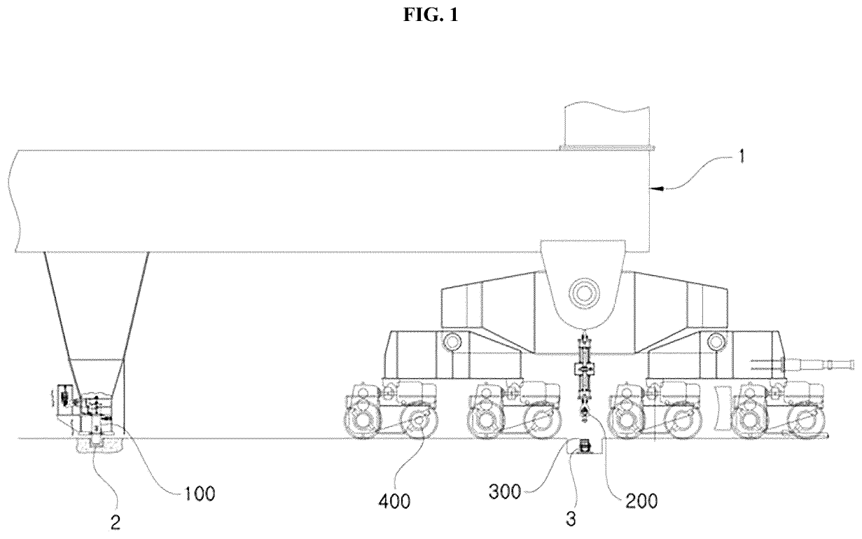

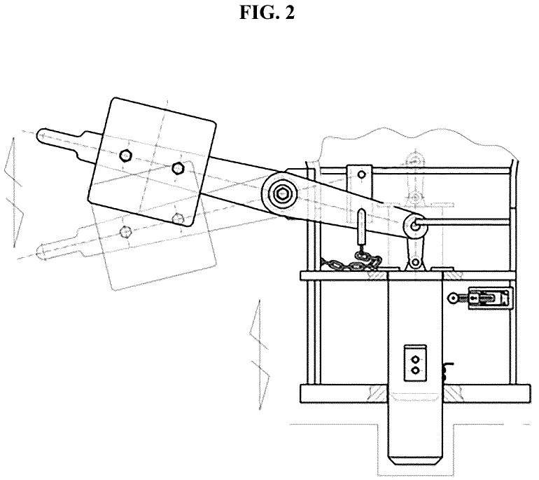

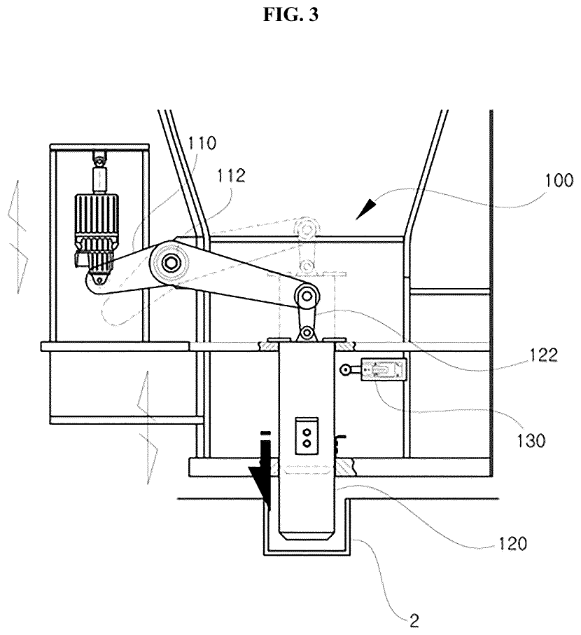

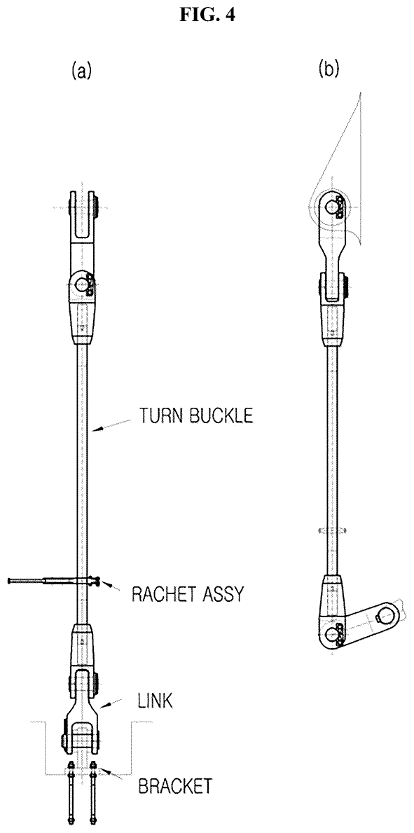

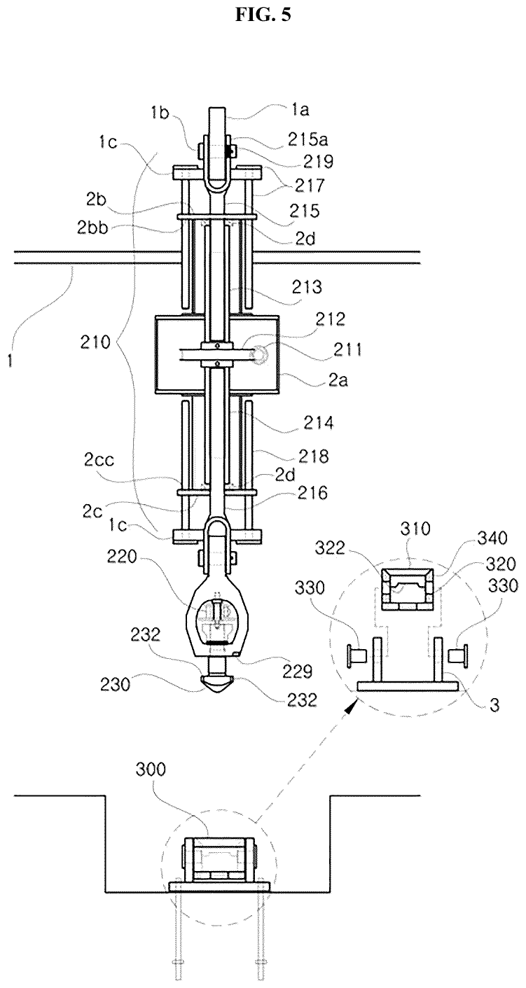

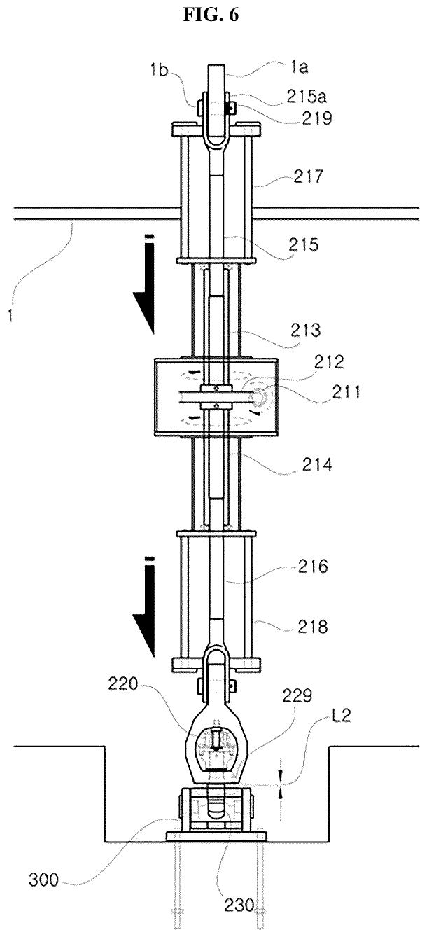

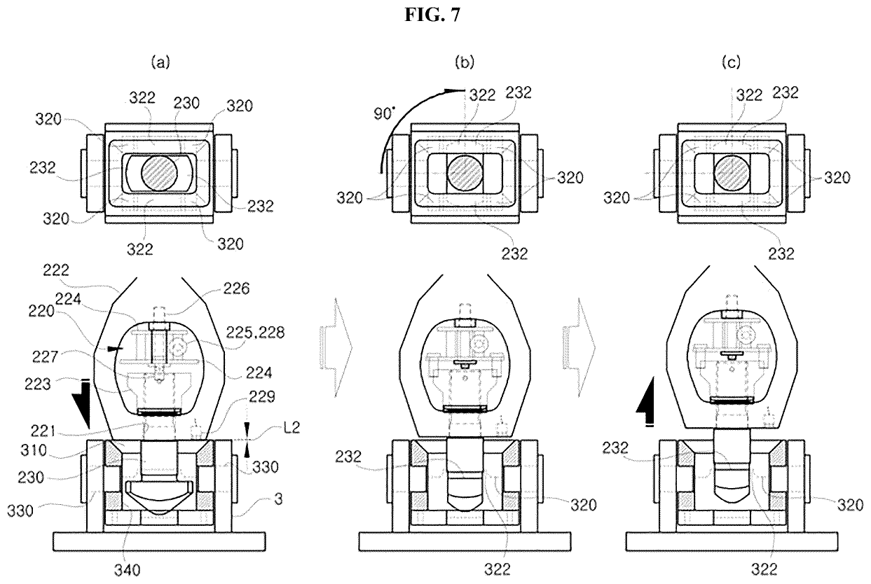

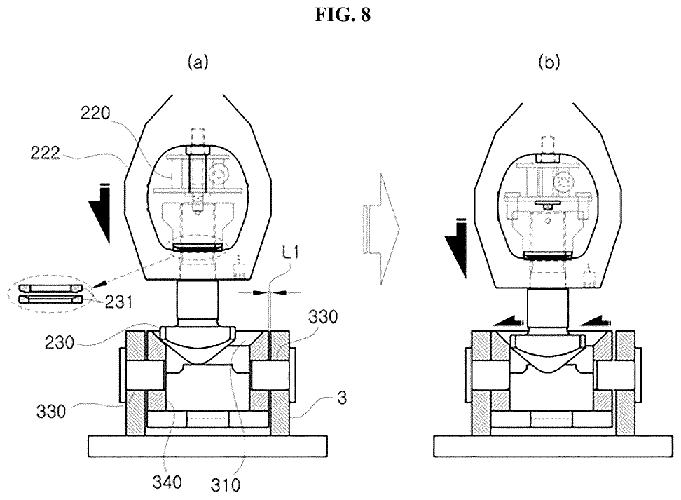

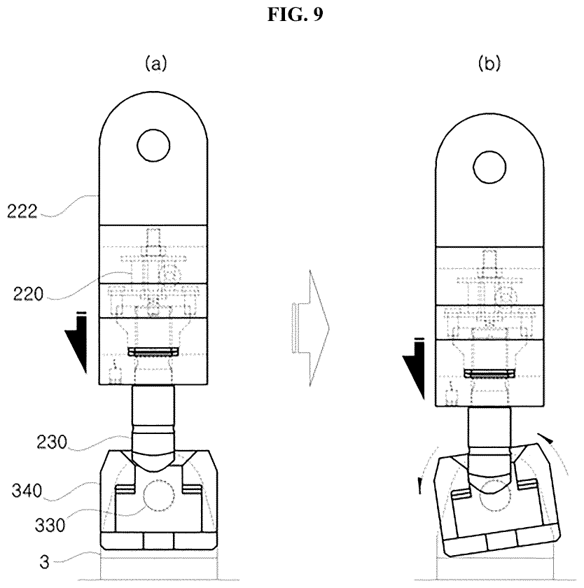

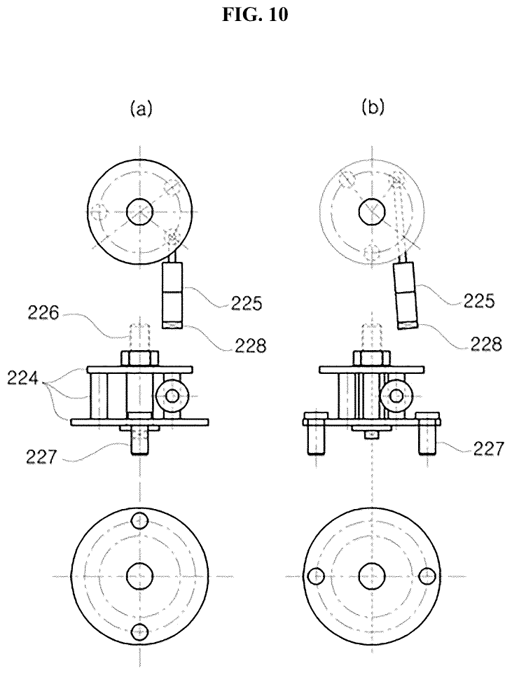

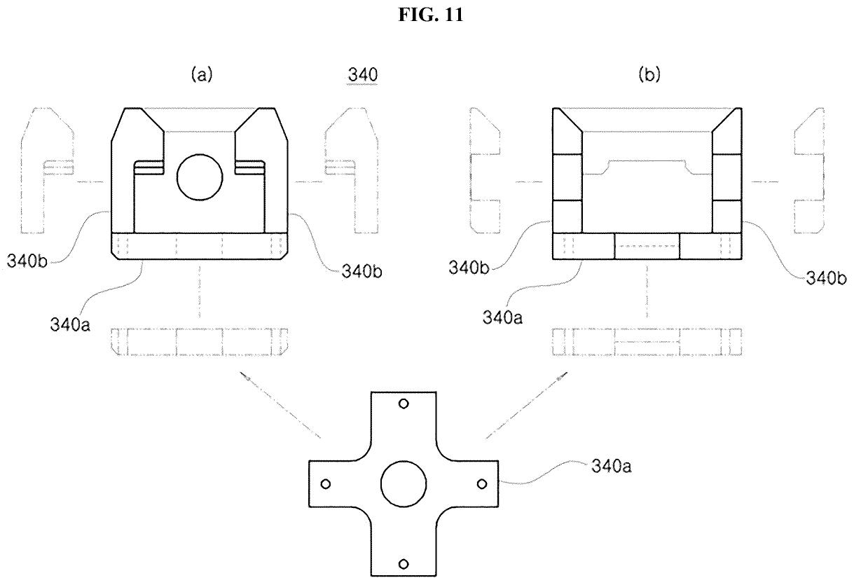

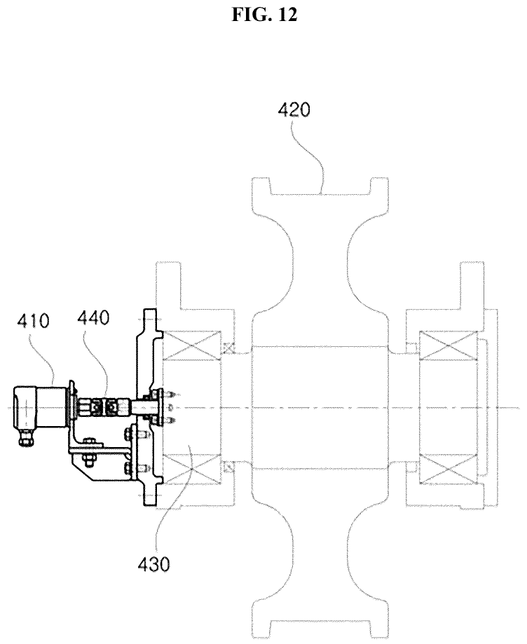

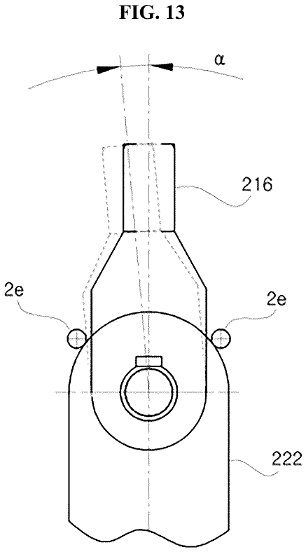

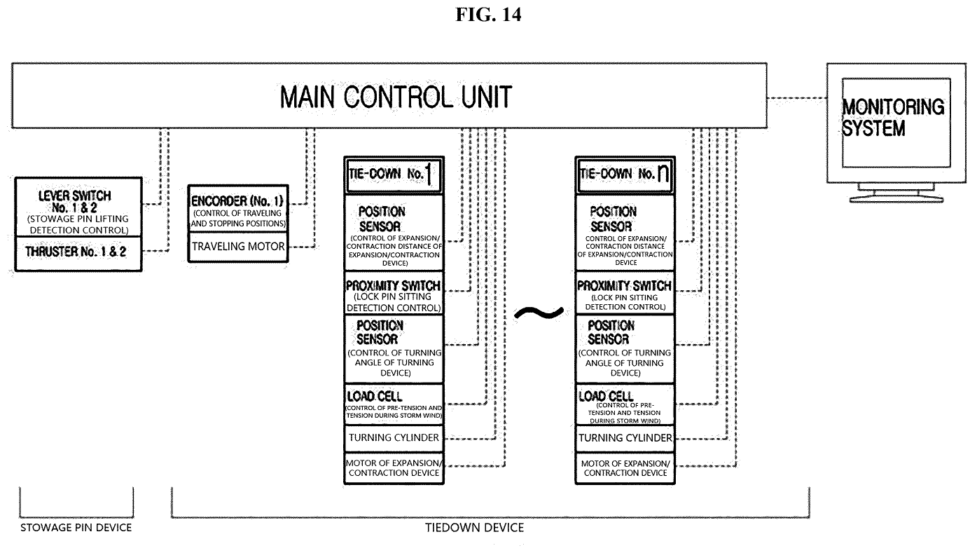

FIG. 1 is a configuration diagram illustrating the overall automated system for safely securing container cranes according to one embodiment of the present invention, FIG. 2 is a configuration diagram illustrating a manual type stowage module for container cranes that is in use according to one embodiment of the present invention, FIG. 3 is a configuration diagram illustrating a stowage module of the automated system for safely securing container cranes according to one embodiment of the present invention, FIG. 4 is a configuration diagram illustrating a manual type tiedown module for container cranes that is in use according to one embodiment of the present invention, FIGS. 5 and 6 are configuration diagrams illustrating a state in which expansion/contraction of a tiedown module of the automated system for safely securing container cranes according to one embodiment of the present invention is controlled by an expansion/contraction device, wherein FIG. 5 is a view of a state in which the tiedown module is contracted while a crane is used, and FIG. 6 is a view of a state in which the tiedown module is completely secured and fastened at the time of storm wind, FIG. 7A is a view of a state in which expansion is stopped after a proximity switch detection distance L2 is reached via stepped portions due to the operation of the expansion/contraction device, FIG. 7B is a view of a state in which 90° turning by a turning device is completed after detection of a proximity switch, FIG. 7C is a view of a state in which, when pre-tension set by a load cell 219 is reached after pre-tension begins to be generated as upper surfaces of catching steps 232 of a twist lock pin 230 come in contact with a lower surface of a lock groove 322 via the stepped portions due to a contracting operation of the expansion/contraction device after completion of 90° rotation is detected by a position sensor (228), the contracting operation is stopped and a fastening task is completed, FIGS. 8 and 9 are configuration diagrams illustrating a state in which the position of a socket anchor module of the automated system for safely securing container cranes according to one embodiment of the present invention is corrected, FIG. 10 is a configuration diagram illustrating a structure of the turning device of the automated system for safely securing container cranes according to one embodiment of the present invention and a state in which the twist lock pin is turned by the turning device, FIG. 11 is a configuration diagram illustrating a socket body of the automated system for safely securing container cranes according to one embodiment of the present invention in an exploded state, FIG. 12 is a configuration diagram illustrating an encoder module of the automated system for safely securing container cranes according to one embodiment of the present invention, FIG. 13 is a configuration diagram illustrating an angle-of-rotation limiting stopper (2e) of a lock pin holder (222) of the automated system for safely securing container cranes according to one embodiment of the present invention, and FIG. 14 is a configuration diagram illustrating a control system conceptual diagram of the automated system for safely securing container cranes according to one embodiment of the present invention.

The present invention relates to an automated system for safely securing container cranes against storm wind. The automated system mainly includes a stowage module 100, a tiedown module 200, a socket anchor module 300, and an encoder module 400, and due to an improved structure in which a stowage module and a tiedown module are remotely controlled by unmanned automation, can significantly decrease the crane securing time to about 1/25 per crane and about 1/500 based on a total of 20 cranes in a terminal compared to a manual type, thus promptly dealing with emergency situations, such as storm wind, with maximum terminal operation efficiency and minimum manpower, and in particular, by recording data of an overload applied to the tiedown module 200 at the time of storm wind using a monitoring system including a load cell and keeping, managing, and analyzing the data as big data, can pre-identify information of a tiedown module expected to be damaged, an expected degree of damage, and the like, predict failures and critical accidents through non-destructive inspection or the like of whether the corresponding module is damaged, and by controlling pre-tension to be evenly applied to each tiedown module 200, can prevent secondary safety accidents including the occurrence of tiedown module breakage accidents due to a local overload applied only to any one tiedown module 200 and the collapse of the entire crane caused thereby, and the occurrence of local deformations of a structure.

The stowage module 100 according to the present invention is installed on a dedicated structure (stowage frame) located at the center of a lower structure 1 (sill beam) of each of a land-side leg and a sea-side leg of a crane and is provided to be operated by a driving source including a thruster and engaged with a pin cup 2 installed at a bottom of a pier so that resistance to horizontal pushing is applied thereto.

A total of four stowage modules 100, two at the land side and two at the sea side, may be disposed on the dedicated structure located at the center of the lower structure at each of the land side and the sea side of the crane. Here, the pin cup 2 is constructed to be buried in the bottom of the pier and is provided to have an upper portion formed as an open cup structure in order for a stowage pin 120 of the stowage module 100 to be inserted thereinto.

In FIG. 3, the stowage module 100 includes a stowage arm 110 configured to turn about a connection pin 112 by the driving source including the thruster, the stowage pin 120 connected to an end of the stowage arm 110 by a link piece 122 and provided to be engaged with the pin cup 2 by linearly moving in a vertical direction in association with the turning of the stowage arm 110, and a sensor 130 configured to detect an operational position of the stowage pin 120.

That is, since the stowage arm 110 turns about the connection pin 112 as a reference point and has a point of force to which power of the driving source is applied formed at one end and a point of application to which the link piece 122 is connected formed at the other end, a vertical movement width of the stowage pin 120 may be expanded in a structure that is compact in a height direction.

Also, the driving source turning the stowage arm 110 is provided to be remotely controlled via a wire or wirelessly.

Thus, since a conventional structure in which a lever is manually operated to lift and lower the stowage pin 120 is improved to a structure in which the stowage pin 120 is remotely controlled automatically, there are advantages in that it is possible to promptly deal with emergency situations with minimum manpower, and the terminal operation efficiency can be maximized because the crane securing time is significantly shortened due to remotely controlling the operation of the stowage pin 120.

Also, the tiedown module 200 according to the present invention is installed at the lower structure 1 of each of the land-side leg and the sea-side leg of the crane, is length-adjusted by an expansion/contraction device 210, and has the twist lock pin 230 provided to be turned by a turning device 220.

In FIG. 5, the expansion/contraction device 210 of the tiedown module 200 includes a worm gear 212 configured to rotate by being engaged with a worm 211 rotated by a driving source such as a motor installed inside or outside a worm gear box 2a whose position is fixed to a crane main body by a pin, a position sensor mounted on the worm 211 to detect and control an expansion/contraction distance of the expansion/contraction device, upper and lower internal screw hollow shafts 213 and 214 or an integrated internal screw hollow shaft integrally connected to both sides or an inner side of the worm gear 212, seated on a bearing 2d, and having internal screw portions formed in reverse directions from each other on an inner circumferential surface, an upper external screw expansion/contraction rod 215 screw-coupled to the upper internal screw hollow shaft 213 and having a securing holder 215a formed at an end to be coupled to a main body bracket 1a, which is welded and attached to the lower structure 1 of each of the land-side leg and the sea-side leg of the crane, by a securing pin 1b, a lower external screw expansion/contraction rod 216 screw-coupled to the lower internal screw hollow shaft 214 and having the twist lock pin 230 turnably provided at an end, upper and lower guides 217 and 218 configured to guide linear movement of the upper and lower external screw expansion/contraction rods 215 and 216 which are pitch-moved in reverse directions from each other due to rotation of the upper and lower internal screw hollow shafts 213 and 214, the load cell 219 installed inside a frame 1c welded and attached to both sides of the securing holder 215a to mount the upper and lower guides, upper and lower boxes 2b and 2c and guide holes 2bb and 2cc configured to block rotation of the entire expansion/contraction device 210, and the securing pin 1b to detect pre-tension applied to the tiedown module 200 and securing tension that is generated and applied at the time of storm wind, and a position sensor mounted on the worm to control an expansion/contraction distance of the upper and lower external screw expansion/contraction rods 215 and 216.

Since the expansion/contraction of the tiedown module 200 is controlled as the upper and lower external screw expansion/contraction rods 215 and 216 linearly move in reverse directions from each other due to the rotation of the worm gear 212, when the length of the tiedown module 200 is expanded as in FIG. 4, as the upper and lower internal screw hollow shafts 213 and 214 and the lower external screw expansion/contraction rod 216 simultaneously move downward based on the upper external screw expansion/contraction rod 215 secured to the main body bracket 1a, which is welded and attached to the lower structure 1 of each of the land-side leg and the sea-side leg of the crane, by the securing pin 1b, the expansion is promptly performed within a short time, and thus the securing time is significantly shortened, and then, when the tiedown module 200 is contracted, as in FIG. 5, the upper and lower external screw expansion/contraction rods 215 and 216 are screw-coupled to the upper and lower internal screw hollow shafts 213 and 214, and the tiedown module 200 is contracted to have a compact structure that does not interfere with a traveling operation of the crane.

Also, in FIG. 14, since values detected by the load cell 219 are collected and analyzed (managed as big data) by a main control unit and the monitoring system to detect and manage crane securing information including overloading of securing tension and eccentric loading of securing tension, a system is constructed to predict failures and accidents by analyzing and managing whether an overload has occurred, the size of the overload and an influence thereof on key components, whether a failure has occurred, whether replacement of components is necessary, and the like through construction of a system for detecting and managing tension including an overload generated on key components of the tiedown module 200 due to an external force caused by storm wind and collection and analysis of tension data.

In this way, since the values detected by the load cell 219 are analyzed and compared with values of securing tension applied to the expansion/contraction device 210, and set initial securing tension is controlled to be evenly applied to each tiedown module 200 using the worm 211 and the worm gear 212, there are advantages in that, while a local overload of more than allowable stress according to design is fundamentally prevented from occurring in any specific tiedown module 200 due to an external force caused by storm wind, the occurrence of breakage accidents and the collapse of the entire crane due to one-sided overloading can be prevented, and in particular, secondary problems such as the occurrence of local deformations of a crane structure can be prevented.

In FIGS. 7 to 10, the turning device 220 of the tiedown module 200 includes a lock pin holder 222 connected to an end of the lower external screw expansion/contraction rod 216 by a pin and having an axial hole 221 formed therethrough for the twist lock pin 230 to be rotatably inserted into the axial hole 221 to support and transfer a securing load, a nut 223 screw-fastened to an end of the twist lock pin 230 inserted to pass through the axial hole 221, a spherical seat 231 mounted on a lower surface of the nut and configured to allow the twist lock pin 230 to freely move in any direction by a predetermined gap within the axial hole 221 and allow the upper surfaces of the catching steps 232 at both ends of the twist lock pin 230 and the lower surface of the lock groove 322 to completely come in close contact, a rotation pin 227 configured to amplify a rotational force by connecting the nut 223 and a turning arm 224 controlling the turning of the twist lock pin 230 by expansion/contraction of a hydraulic or electric cylinder 225, a proximity switch 229 installed inside or outside a reference shaft 226, about which the turning arm 224 rotates, or the lock pin holder 222 to have an upper surface of the socket anchor module 300 as a detection target, and a position sensor 228 installed on a shaft of the cylinder 225 that controls a 90° turning section of the twist lock pin 230.

Here, in FIG. 8, the axial hole 221 is formed to have a size that is expanded compared to the twist lock pin 230, and since the twist lock pin 230 is fastened to the nut 223 in a state in which the spherical seat 231 is fitted to the twist lock pin 230, the twist lock pin 230 is able to freely move in any direction by a predetermined gap within the axial hole 221, and due to the spherical seat 231, as the twist lock pin 230 moves about the axial hole 221, the upper surfaces of the catching steps 232 at both ends of the twist lock pin 230 and the lower surface of the lock groove 322 may completely come in close contact. Here, the spherical seat 231 is mounted on the lower surface of the nut to allow the twist lock pin 230 to freely move in any direction by a predetermined gap within the axial hole 221.

In this way, by introducing a fastening method in which the twist lock pin 230 is configured to be automatically controlled to expand/contract and turn by a driving source, and the tiedown module 200 is easily fastened or unfastened just by 90° rotation of the twist lock pin 230, there is an advantage in that worker safety can be secured due to unmanned automation of the entire process of a task of fastening/unfastening the tiedown module 200.

Also, during the expansion of the expansion/contraction device 210, due to a horizontal force caused by a protruding inclined surface of the twist lock pin 230 coming in contact with an inclined surface at an inlet of the socket anchor module 300 due to a vertical axial force, the position of a socket hole 310 may be corrected so that the twist lock pin 230 smoothly enters the socket hole.

Also, the socket anchor module 300 is mounted on anchoring hinges 3 installed to be fixed to the bottom of the pier by an anchor bolt and is provided to be engaged with the twist lock pin 230 of the tiedown module 200 to bind the lower structure 1 of each of the land-side leg and the sea-side leg of the crane.

In FIG. 7, the twist lock pin 230 has a front end sharply protruding at a constant angle of inclination and has a pair of catching steps 232 formed at both ends. The socket anchor module 300 of the tiedown module 200 has the long socket hole 310 formed to accommodate the twist lock pin 230, an inclined surface is formed at an inlet of the socket hole 310, and a pair of stepped portions 320 are disposed to be spaced apart from each other right below the inclined surface at the inlet of the socket hole 310.

Also, after the twist lock pin 230 moves over the inclined surface at a predetermined angle and sufficiently enters the socket hole 310 via the stepped portions 320 due to expansion of the upper and lower external screw expansion/contraction rods 215 and 216 as in FIG. 7A, and then the twist lock pin 230 turns 90° as in FIG. 7B due to detection of the proximity switch, due to contraction of the expansion/contraction device as in FIG. 7C, the upper surfaces of the catching steps 232 at both ends of the twist lock pin 230 are restrained to come in contact with the lower surface of the lock groove 322, pre-tension begins to be generated, and pre-tension set by the load cell 219 is reached. Then, the contraction stops and the fastening task is completed, and since the catching steps at both ends of the twist lock pin are firmly restrained to the stepped portions, unintended loosening of the twist lock pin 230 due to an external force caused by storm wind is fundamentally prevented.

In FIGS. 8 and 9, the socket anchor module 300 of the tiedown module 200 includes a pair of support shafts 330 fastened to the anchoring hinges 3 installed to be fixed to the bottom of the pier by an anchor bolt, and a socket body 340 having both ends restrained to the support shafts 330 to be rotatably installed and having the socket hole 310 formed therein.

The anchoring hinge 3 includes a bottom plate mounted to be fixed to the bottom of the pier by an anchor bolt and a pair of side plates formed at both ends of the bottom plate in the vertical direction, and the support shafts 330 are installed on the side plates.

Also, the socket body 340 forms a predetermined transverse correction gap L1 movable in an axial direction of the support shafts 330 between the anchoring hinges 3, and the position of the socket hole 310 is automatically corrected to coincide with the twist lock pin 230 as the position of the socket body 340 is moved in the axial direction of the support shafts 330 by the transverse correction gap L1 or the socket body 340 is turned about the support shafts 330 due to a horizontal force caused by the protruding inclined surface of the twist lock pin 230 coming in contact with an inclined surface at an inlet of the socket body 340 while at a position not coinciding with the socket hole 310 due to being transferred downward.

Here, when the twist lock pin 230 enters the long socket hole 310 while forming an angle misaligned with the long socket hole 310 within a predetermined allowable range, as a one-side inclined surface of the front end of the twist lock pin 230 and a one-side inclined surface of an inlet of the socket anchor module 300 come in contact due to a an expansion force of the expansion/contraction device 210 that is generated by the driving source, a rotating moment acts on the twist lock pin 230, and when the rotating moment of the twist lock pin 230 is large compared to an initial set pressure of the cylinder 225, as the cylinder is contracted or expanded, the twist lock pin 230 is rotated, and the angle of the twist lock pin 230 is automatically corrected so that the twist lock pin 230 enters the long socket hole 310.

Also, an angle-of-rotation limiting stopper 2e is installed by welding or assembly to a side surface of the lock pin holder 222 to allow the lock pin holder 222 to rotate only within an angle α around 1 to 2° for the purpose of partially complementing functions of limiting excessive shaking due to acceleration or deceleration occurring during a traveling operation of a container crane and automatically correcting deviation amounts (a deviation in straightness of a traveling rail, a deviation in gaps between traveling wheel treads, a deviation in traveling, securing, and stopping positions) of the lock pin holder 222 assembled to the lower external screw expansion/contraction rod 216 by a pin.

Also, the socket body 340 forms a section of the socket hole 310 by a bottom plate 340a serving as a balance weight and four side plates 340b disposed at four sides of the bottom plate 340a as in FIG. 11, and the bottom plate 340a and the side plates 340b have a bolting assembly structure applied thereto to allow a center-of-mass position to be adjusted by adjusting the size of the bottom plate. A cross shape (+) of the bottom plate facilitates bolt assembly, a circular hole at a central portion serves as a clearance for insertion of the twist lock pin 230, and since the height of the anchoring hinges 3 is minimized, a depth at which the anchoring hinges 3 are buried in the bottom of the pier is minimized. This makes it essential to add an installation space due to automation in which the socket anchor module 300 is added compared to a conventional manual type, but by designing to minimize a necessary space such as a burying depth, an automation method may be easily modified and applied to a site to which the conventional manual type is applied, without separate modification work for a civil engineering part.

In a state in which the socket body 340 is turnably fastened to the support shafts 330, the center of mass of the entire socket body whose bottom plate is bolt-assembled is caused to be biased toward lower portions of the support shafts 330 so that the inlet of the socket hole 310 always remains facing upward due to gravity for the twist lock pin 230 to be smoothly inserted into the socket hole 310.

Also, the position of the socket hole 310 is corrected to coincide with the twist lock pin 230 as the position of the socket body 340 is moved in the axial direction of the support shafts 330 by the transverse correction gap L1 as in FIG. 8A or the socket body 340 is turned about the support shafts 330 as in FIG. 8B due to a horizontal force caused by the twist lock pin 230 coming in contact with the inclined surface at the inlet of the socket body 340 while at a position not coinciding with the socket hole 310 due to being transferred downward.

In addition, in the task of fastening/unfastening the tiedown module 200, as compared to a difficult fastening/unfastening method in which a pin is manually fitted or removed, a structure that enables fastening and unfastening to be simply performed just by the twist lock pin 230 turning 90° is applied, a structure that enables the twist lock pin to be easily fastened at a constant position at all times by detection of the proximity switch 229 regardless of deviations and changes in the level of the upper surface of the traveling rail is applied, and a socket anchor module having a freestanding structure that allows a socket hole to always face upward to facilitate insertion of the twist lock pin 230 into the socket hole is applied. Thus, even when the twist lock pin 230 and the socket hole 310 do not coincide with each other in a straight line due to an error or the like in traveling and stopping positions of the crane, since the deviation amounts (a deviation in straightness of a traveling rail, a deviation in gaps between traveling wheel treads, a deviation in traveling and stopping positions) are automatically corrected by moving an angle of rotation of the twist lock pin 230 and moving the position of the socket body 340, the operation of fastening and unfastening the tiedown module 200 may be performed by unmanned automation.

FIG. 13 relates to the angle-of-rotation limiting stopper 2e of the lock pin holder 222 that constitutes the automated system for safely securing container cranes according to one embodiment of the present invention. The angle-of-rotation limiting stopper 2e is installed by welding or assembly to a side surface of the lock pin holder 222 to allow the lock pin holder 222 to rotate only within the angle α around 1 to 2° for the purpose of partially complementing functions of limiting excessive shaking due to acceleration or deceleration occurring during a traveling operation of a container crane and automatically correcting the deviation amounts (a deviation in straightness of a traveling rail, a deviation in gaps between traveling wheel treads, a deviation in traveling, securing, and stopping positions) of the lock pin holder 222 assembled to the lower external screw expansion/contraction rod 216 by a pin.

FIG. 14 relates to an operation control procedure for the automated system for safely securing container cranes according to one embodiment of the present invention. The automated system includes an automation control system of the main control unit that includes a driving source, a sensor, a data collection device, a control programmable logic controller (PLC), and the like for automation of a task of securing the stowage module and the tiedown module, a monitoring system configured to predict failures and accidents by analyzing and managing whether an overload has occurred, the size of the overload and an influence thereof on key components, whether a failure has occurred, whether replacement of components is necessary, and the like through collection and analysis of tension data including an overload occurring in key components of the tiedown module 200 detected by the load cell, and a pre-tension even distribution control device configured to, by utilizing the tension detection function using the load cell 219, control set initial securing tension to be evenly applied to each tiedown module 200 using the worm 211 and the worm gear 212 to fundamentally prevent a local overload of more than allowable stress according to design from occurring in any specific tiedown module 200 due to an external force caused by storm wind and prevent the occurrence of breakage accidents and the collapse of the entire crane due to one-sided overloading.

That is, in the fastening procedure, according to a securing task start signal of a driver from a crane driving room or an auxiliary driving room, a crane is stopped at a set securing position by operation and control of an encoder 410 or a lever switch installed on an idle shaft 430 of an idle wheel 420 during a low-speed traveling operation to the securing position; then, a task of fastening the stowage module 100 is completed as the stowage pin 120 is inserted into the pin cup 2 due to an operation of a driving source such as a thruster being stopped; in the tiedown module 200, as soon as the stowage module starts, expansion of the expansion/contraction device 210 starts due to operations of the worm 211 (including an operation of the position sensor) and the worm gear 212 by a driving source such as a motor, and the expansion of the expansion/contraction device stops when the twist lock pin 230 is detected within the set distance L2 from the proximity switch 229 after entering the socket hole 310 and passing the stepped portions 320; then, turning starts due to an operation of the cylinder 225 which is a driving source of the turning device 220, and turning is stopped by the position sensor 228 mounted on the cylinder 225 after turning 90°; and then contraction of the expansion/contraction device 210 starts, set pre-tension begins to be generated as the upper surfaces of the catching steps 232 at both ends of the twist lock pin 230 come in contact with the lower surface of the lock groove 322, and when pre-tension set by the load cell 219 is reached, the contraction stops, and the fastening task is completed. In the unfastening procedure, the above steps are performed in a reverse order from the fastening procedure, the task of unfastening the tiedown module is completed when a set contraction distance from the position sensor for controlling the expansion/contraction distance is reached through a set turning angle (−90°) operation of the position sensor 228 for controlling a turning angle after the set distance L2 operation of the proximity switch 229; and the task of unfastening the stowage module 100 is completed when a lever switch 130 is detected after the stowage pin 120 is lifted and reaches an upper lifting limit due to an operation of the thruster which is a driving source.

The most preferable embodiments of the present invention have been described in the above detailed description of the present invention, but various modifications are possible within the scope not departing from the technical scope of the present invention. Therefore, the protection scope of the present invention should not be defined as being limited to the above-described embodiments, but should be recognized as also pertaining to the claims below and similar technical means that may be derived from the claims. The protection scope should also apply to container cranes as well as equipment such as a transfer crane, a dockyard Goliath crane, a jib crane, a loader and an unloader for a steel mill (a ship loader, a continuous ship unloader (CSU), a grab type ship unloader (GTSU)), and an unloader and a stacker-reclaimer (STRE) for a thermoelectric power plant (a CSU, an STRE) that are installed and operated in an outdoor area affected by storm wind.

[Description of reference numerals]

| | |
|---|---|
| 100: stowage module | 200: tiedown module |
| 300: socket anchor module | 400: encoder module |

1. An automated system for safely securing container cranes against storm wind, the automated system comprising:
a stowage module (100) installed at a dedicated structure (stowage frame) located at a center of a lower structure (1) (sill beam) of each of a land-side leg and a sea-side leg of a crane and provided to be operated by a driving source including a thruster and engaged with a pin cup (2) installed at a bottom of a pier so that resistance to horizontal pushing caused by storm wind is applied thereto;
a tiedown module (200) installed at the lower structure (1) of each of the land-side leg and the sea-side leg of the crane, length-adjusted by an expansion/contraction device (210), and having a twist lock pin (230) and a nut (223) configured to be turned by a turning device (220);
a socket anchor module (300) mounted on anchoring hinges (3) installed to be fixed to the bottom of the pier by an anchor bolt and provided to be engaged with the twist lock pin (230) of the tiedown module (200) to bind the lower structure (1) of each of the land-side leg and the sea-side leg of the crane; and
an encoder module (400) consisting of a traveling idle wheel (420), an idle shaft (430), and a connection coupling (440) for mounting an encoder (410) for controlling a traveling device to accurately stop the crane at a securing position,
wherein the twist lock pin (230) of the tiedown module (200) has a front end sharply protruding while forming a constant angle of inclination and has a pair of catching steps (232) formed at both ends,
the socket anchor module (300) of the tiedown module (200) has a long socket hole (310) formed to accommodate the twist lock pin (230), an inclined surface is formed right below the long socket hole (310), and a pair of stepped portions (320) are disposed to be spaced apart from each other right below the inclined surface at an inlet of the long socket hole (310), and
after the twist lock pin (230) moves over the inclined surface at a predetermined angle and sufficiently enters the long socket hole (310) via the stepped portions (320) due to expansion of upper and lower expansion/contraction rods (215, 216) and then the twist lock pin (230) turns (+) 90° due to an operation of a proximity switch (229), as the expansion/contraction device (210) is contracted, and upper surfaces of the catching steps (232) of the twist lock pin (230) come in contact with a lower surface of a lock groove (322) via the stepped portions, pre-tension begins to be generated, and when pre-tension set by a load cell (219) is reached, the contraction stops and a fastening task is completed, and in a state in which the twist lock pin (230) in which expansion/contraction of the expansion/contraction device is stopped is fastened, since the catching steps (232) at both ends of the twist lock pin are engaged with the stepped portions (320) and turning (−) 90°, that is, loosening, is not possible, at the time of storm wind, an accident in which the crane is overturned due to the twist lock pin (230) being unfastened is fundamentally prevented even when the tiedown module (200) shakes violently or the turning device (220) malfunctions.

2. The automated system of claim 1, wherein the stowage module (100) includes:
a stowage arm (110) configured to turn about a connection pin (112) by the driving source including the thruster;
a stowage pin (120) connected to an end of the stowage arm (110) by a link piece (122) and provided to be engaged with the pin cup (2) by linearly moving in a vertical direction in association with the turning of the stowage arm (110); and
a sensor (130) configured to detect an operational position of the stowage pin (120).

3. The automated system of claim 1, wherein the expansion/contraction device (210) of the tiedown module (200) includes:
a worm gear (212) configured to rotate by being engaged with a worm (211) rotated by a driving source such as a motor installed inside or outside a worm gear box (2a) whose position is fixed to a crane main body by a pin;
a position sensor mounted on the worm (211) to detect and control an expansion/contraction distance of the expansion/contraction device;
upper and lower internal screw hollow shafts (213) (214) or an integrated internal screw hollow shaft (214) integrally connected to both sides or an inner side of the worm gear (212), seated on a bearing (2d), and having internal screw portions formed in reverse directions from each other on an inner circumferential surface;
an upper external screw expansion/contraction rod (215) screw-coupled to the upper internal screw hollow shaft (213) and having a securing holder (215a) formed at an end to be coupled to a main body bracket (1a), which is welded and attached to the lower structure (1) of each of the land-side leg and the sea-side leg of the crane, by a securing pin (1b);
a lower external screw expansion/contraction rod (216) screw-coupled to the lower internal screw hollow shaft (214) and having the twist lock pin (230) turnably provided at an end;
upper and lower guides (217) (218) configured to guide linear movement of the upper and lower external screw expansion/contraction rods (215) (216) which are pitch-moved in reverse directions from each other due to rotation of the upper and lower internal screw hollow shafts (213) (214); and
the load cell (219) installed inside a frame (1c) welded and attached to both sides of the securing holder (215a) to mount the upper and lower guides, upper and lower boxes (2b, 2c) and guide holes (2bb, 2cc) configured to block rotation of the entire expansion/contraction device (210), and the securing pin (1b) to detect pre-tension applied to the tiedown module (200) and securing tension that is generated and applied at the time of storm wind,
wherein values detected by the load cell (219) are collected and analyzed by a main control unit to detect and manage crane securing information including overloading of securing tension and eccentric loading of securing tension.

4. The automated system of claim 1, wherein the turning device (220) of the tiedown module (200) includes:
a lock pin holder (222) connected to an end of the lower external screw expansion/contraction rod (216) by a pin and having an axial hole (221) formed therethrough for the twist lock pin (230) to be rotatably inserted into the axial hole (221) to support and transfer a securing load;
the nut (223) screw-fastened to an end of the twist lock pin (230) inserted to pass through the axial hole (221);
a spherical seat (231) mounted on a lower surface of the nut and configured to allow the twist lock pin (230) to freely move in any direction by a predetermined gap within the axial hole (221) and allow the upper surfaces of the catching steps (232) at both ends of the twist lock pin (230) and the lower surface of the lock groove (322) to completely come in close contact;
a rotation pin (227) configured to amplify a rotational force by connecting the nut (223) and a turning arm (224) controlling the turning of the twist lock pin (230) by expansion/contraction of a hydraulic or electric cylinder (225);
the proximity switch (229) installed inside or outside a reference shaft (226), about which the turning arm (224) rotates, or the lock pin holder (222) to have an upper surface of the socket anchor module (300) as a detection target; and
a position sensor (228) installed on a shaft of the cylinder (225) that controls a 90° turning section of the twist lock pin (230).

5. The automated system of claim 1, wherein the socket anchor module (300) of the tiedown module (200) includes:
a pair of support shafts (330) fastened to be fixed to the anchoring hinges (3) installed to be fixed to the bottom of the pier by an anchor bolt; and
a socket body (340) having both ends restrained to the support shafts (330) to be rotatably installed and having the long socket hole (310) formed therein,
wherein the socket body (340) forms a predetermined transverse correction gap (L1) movable in an axial direction of the support shafts (330) between the anchoring hinges (3), and the position of the long socket hole (310) is automatically corrected to coincide with the twist lock pin (230) as the position of the socket body (340) is moved in the axial direction of the support shafts (330) by the transverse correction gap (L1) or the socket body (340) is turned about the support shafts (330) due to a horizontal force caused by the protruding inclined surface of the twist lock pin (230) coming in contact with an inclined surface at an inlet of the socket body (340) while at a position not coinciding with the socket hole (310) due to being transferred downward,
when the twist lock pin (230) enters the long socket hole (310) while forming an angle misaligned with the long socket hole (310) within a predetermined allowable range, as a one-side inclined surface of the front end of the twist lock pin (230) and a one-side inclined surface of an inlet of the socket anchor module (300) come in contact due to an expansion force of the expansion/contraction device (210) that is generated by the driving source, rotating moment is applied to the twist lock pin (230), and when the rotating moment of the twist lock pin (230) is large compared to an initial set pressure of the cylinder (225), as the cylinder is contracted or expanded, the twist lock pin (230) is rotated, and the angle of the twist lock pin (230) is automatically corrected so that the twist lock pin (230) enters the long socket hole (310), and
an angle-of-rotation limiting stopper (2e) is installed by welding or assembly to a side surface of the lock pin holder (222) to allow the lock pin holder (222) to rotate only within an angle (a) around 1 to 2° for the purpose of partially complementing functions of limiting excessive shaking due to acceleration or deceleration occurring during a traveling operation of a container crane and automatically correcting deviation amounts (a deviation in straightness of a traveling rail, a deviation in gaps between traveling wheel treads, a deviation in traveling, securing, and stopping positions) of the lock pin holder (222) assembled to the lower external screw expansion/contraction rod (216) by a pin.

6. The automated system of claim 5, wherein:
the socket body (340) forms a section of the socket hole (310) by a bottom plate (340a) serving as a balance weight and four side plates (340b) disposed at four sides of the bottom plate (340a), the bottom plate (340a) and the side plates (340b) have a bolting assembly structure applied thereto to allow a center-of-mass position to be adjusted by adjusting the size of the bottom plate and cause the center of mass of the entire socket body to be biased toward lower portions of the support shafts (330) so that the inlet of the socket hole (310) always remains facing upward due to gravity for the twist lock pin (230) to be smoothly inserted into the socket hole (310); and
a cross shape (+) of the bottom plate facilitates bolt assembly, a circular hole at a central portion serves as a clearance for insertion of the twist lock pin (230), and although the height of the anchoring hinges (3) is minimized and a depth at which the anchoring hinges (3) are buried in the bottom of the pier is minimized, which makes it essential to add an installation space due to automation in which the socket anchor module (300) is added compared to a conventional manual type, by designing to minimize a necessary space such as a burying depth, an automation method is able to be easily modified and applied to a site to which the conventional manual type is applied, without separate modification work for a civil engineering part.

7. The automated system of claim 3, further comprising:
an automation control system of the main control unit that includes a driving source, a sensor, a data collection device, a control programmable logic controller (PLC), and the like for automation of a task of securing the stowage module and the tiedown module;
a monitoring system configured to predict failures and accidents by analyzing and managing whether an overload has occurred, the size of the overload and an influence thereof on key components, whether a failure has occurred, whether replacement of components is necessary, and the like through collection and analysis of tension data including an overload occurring in key components of the tiedown module (200) detected by the load cell; and
a pre-tension even distribution control device configured to, by utilizing the tension detection function using the load cell (219), control set initial securing tension to be evenly applied to each tiedown module (200) using the worm (211) and the worm gear (212) to fundamentally prevent a local overload of more than allowable stress according to design from occurring in the tiedown module (200) due to an external force caused by storm wind and prevent the occurrence of breakage accidents and the collapse of the entire crane due to one-sided overloading.
